(19) United States
(12) Patent Application Publication
(10) Pub. No.: US 2018/0058304 A1
(43) Pub. Date: Mar. 1, 2018

(54) Engine Fluid Temperature Regulating System and Method

(71) Applicant: TRIZ ENGINEERING SOLUTIONS (PTY) LTD, Cape Town (ZA)

(72) Inventors: Johann Christiaan VORSTER, Cape Town (ZA); Gavin Charles WALTERS, Cape Town (ZA); Walter ZOCHER, Cape Town (ZA)

(21) Appl. No.: 15/555,715

(22) PCT Filed: Mar. 4, 2016
(86) PCT No.: PCT/IB2016/051227

§ 371 Date: Sep. 5, 2017

(30) Foreign Application Priority Data
Mar. 5, 2015 (ZA) 2015/01497

(51) Int. Cl. F01P 11/20; F01P 7/16; F02B 29/04

(52) U.S. Cl. CPC F01P 11/20; F01P 7/16; F01P 2025/52; F02B 29/0493; F01P 2025/13; F02B 29/0418

(57) ABSTRACT

An engine fluid temperature regulating system and method for an engine is provided. The system includes a bypass line configured to be connected in parallel with a heat exchanger between an inlet and an outlet thereof, as well as a flow regulator configurable to regulate a proportion of fluid flowing through the bypass line and heat exchanger, respectively, between the inlet and the outlet. A control unit may be provided to regulate the proportion of fluid flowing through the bypass line and heat exchanger, and temperature sensor may be provided to measure temperatures used to regulate the proportion of fluid flowing through the bypass line and heat exchanger.

### CROSS-REFERENCE(S) TO RELATED APPLICATIONS

This application claims priority from South African provisional patent application number 2015/01497 filed on 5 Mar. 2015, which is incorporated by reference herein.

### FIELD OF THE INVENTION

This invention relates to a system for regulating an engine fluid temperature, particularly in extreme cold weather conditions.

### BACKGROUND TO THE INVENTION

Vehicles may experience unique challenges to various vehicle systems when operating in extreme cold weather environments. Although operating in such conditions may be avoided under some circumstances, some vehicles are required to operate in extreme conditions due to their nature. For example, snow clearing vehicles, waste removal vehicles, or the like may be required to operate in extreme cold conditions.

A particular problem in extreme cold weather environments is the formation of ice at or in an intake manifold (also known as an inlet manifold) of a vehicle engine. In turbo-charged engines, a typical flow path for air on its way to an engine, is from the ambient atmosphere outside the vehicle, through an air inlet, through a turbo, through a charge air cooler (also known as an intercooler), and via the air intake manifold into the engine.

In normal or moderate weather conditions, the air is heated by the turbo, and the charge air cooler operates to cool down the heated air such that its density is suitably increased to allow more efficient and/or optimum operation of the combustion process in the engine. However, in extreme cold weather conditions, the charge air cooler cools air from the turbo down so much that frost tends to form inside the intake manifold. It will be apparent to a person skilled in the art that this is highly undesirable, possibly resulting in sensor damage and/or the blocking of air flow, which in turn may result in reduced engine performance, engine damage, engine breakdown, or the like. Some engines are configured to automatically shut down when detecting such conditions in order to prevent damage, which is of course also undesirable.

An additional problem in extreme cold weather environments is an undesirably high amount of thermal cycling experienced by a radiator of a vehicle. When an engine of a vehicle reaches a predetermined high temperature, a radiator valve associated with the vehicle's engine opens to allow heated coolant of the engine to pass through the radiator, which serves to cool the coolant. The coolant then flows back to the engine and through the engine block, where it cools the engine down. In this manner, heat from the engine is transferred via the coolant to the radiator, where it is dispersed to the ambient air. In extreme cold weather conditions, the radiator may cool the coolant so much that it cools the engine down to a predetermined low temperature which causes the radiator valve to close again. As the valve is closed the engine is not cooled anymore and soon heats up again, resulting in the radiator valve being opened and the cooling process beginning again. This cooling process is continuously initiated and stopped, resulting in the radiator experiencing a high number of thermal cycles. As a result the lifespan of the radiator may be reduced as the radiator may be prone to damage, typically in the form of cracking, due to the frequency of thermal cycles experienced.

To the applicant's knowledge, attempts at addressing these problems have been largely unsuccessful. Insulating covers applied to a charge air cooler may result in a smaller amount of heat being dispersed prior to air reaching the air intake manifold, but inconsistent covering may result in variable temperatures over the charge air cooler, which may cause thermal stress which results in a reduced lifespan. Covers applied to the radiator may have a similar negative effect, and may unfavourably restrict air flow to the radiator. Additionally, such covers may need to be fitted or removed by a trained person, requiring additional preparation time and/or training to implement. Covers remaining on these components may also lead to excessive temperatures if left on when not required. Furthermore, covers typically do not provide a flexible solution—the covers are either completely attached, or removed. Changes in weather conditions, operating conditions, or the like may require different extents of intervention to ensure optimal operation of system components, which is not possible with covers.

In the remainder of the specification, the term “fluid” should be construed to mean any flowable material, including a liquid or a gas.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided an engine fluid temperature regulating system for an engine, the system including:
a bypass line configured to be connected in parallel with a heat exchanger between an inlet and an outlet thereof; and
a flow regulator configurable to regulate a proportion of fluid flowing through the bypass line and heat exchanger, respectively, between the inlet and the outlet.

Further features provide for the system to include a temperature sensor at the inlet and/or the outlet of the heat exchanger; and for the flow regulator to be configured to adjust the proportion of fluid flowing through the heat exchanger and the bypass line, respectively, between the inlet and the outlet so that fluid enters the heat exchanger and bypass line at a target entry temperature, or so that fluid exiting the heat exchanger and the bypass line is at a target exit temperature when mixed together.

Still further features provide for the system to include a control unit; and for the control unit to be configured to automatically adjust the flow regulator to obtain the target entry or exit temperature.

Yet further features provide for the system to include an ambient air temperature sensor for measuring the ambient air temperature; and for the control unit to be configured to take into account the ambient air temperature in adjusting the flow regulator.

A further feature provides for the flow regulator to be a three-way controllable valve.

Still further features provide for the heat exchanger to be a radiator; or for the heat exchanger to be a charge air cooler.

Yet further features provide for the engine to be a turbocharged engine; and for the engine to be a diesel engine, a petrol engine, a liquid petroleum gas engine, or the like.

The invention extends to a method for regulating engine fluid temperature for an engine including the steps of:
connecting a bypass line in parallel with a heat exchanger of the engine between an inlet and an outlet thereof; and
regulating, with a flow regulator, a proportion of fluid flowing through the heat exchanger and the bypass line, respectively, between the inlet and the outlet.

Further features provide for the method to include the step of measuring a temperature at the inlet and/or the outlet of the heat exchanger; and for the regulating step to include regulating the flow such that fluid enters the heat exchanger and bypass line at a target entry temperature, or so that fluid exiting the heat exchanger and the bypass line is at a target exit temperature when mixed together.

Still further features provide for the method to be performed by a control unit, the control unit being operable to automatically adjust the flow regulator to regulate fluid flow to obtain the target entry or exit temperature.

Yet further features provide for the method to include the step of measuring an ambient air temperature; and for the step of regulating a proportion of fluid flowing through the heat exchanger and the bypass line, respectively, to take into account the measured ambient air temperature.

The invention extends to an engine fluid temperature regulating system for an engine, the system including:
a first bypass line configured to be connected in parallel with a radiator of an engine between an inlet and an outlet thereof;
a first flow regulator configurable to regulate a proportion of coolant flowing through the radiator and the first bypass line, respectively, between the inlet and the outlet;
a second bypass line configured to be connected in parallel with a charge air cooler of an engine between an inlet and an outlet thereof; and
a second flow regulator configurable to regulate a proportion of air flowing through the charge air cooler and the second bypass line, respectively, between the inlet and outlet thereof.

Further features provide for the system to include a first temperature sensor at the inlet and/or the outlet of the radiator; for the first flow regulator to be configured to regulate a proportion of coolant flowing through the radiator and the first bypass line so that coolant enters the radiator and first bypass line at a first target entry temperature, or so that coolant exiting the radiator and the first bypass line is at a first target exit temperature when mixed together; and for the system to include a second temperature sensor at the inlet and/or the outlet of the charge air cooler; for the second flow regulator to be configured to regulate a proportion of air flowing through the charge air cooler and the bypass line, respectively, so that air enters the charge air cooler and second bypass line at a second target entry temperature, or so that air exiting the charge air cooler and the second bypass line is at a second target exit temperature when mixed together.

A still further feature provides for the system to include a control unit configured to automatically adjust the first and the second flow regulators to obtain the first and/or second target entry or exit temperatures.

Yet further features provide for the system to include an ambient air temperature sensor; and for the control unit to be configured to take into account the ambient air temperature in adjusting the flow regulator.

An embodiment of the invention will now be described, by way of example only, with reference to the accompanying drawings.

### BRIEF DESCRIPTION OF THE DRAWINGS

In the drawings:

FIG. 1 illustrates an engine fluid temperature regulating system for an engine in accordance with a first exemplary embodiment of the invention;

FIG. 2 is a flow diagram illustrating a method of operation of the system of the first exemplary embodiment as performed by a control unit;

FIG. 3 illustrates an engine fluid temperature regulating system for an engine in accordance with a second exemplary embodiment of the invention;

FIG. 4 illustrates an engine fluid temperature regulating system for an engine in accordance with a third exemplary embodiment of the invention; and

FIG. 5 illustrates an engine fluid temperature regulating system for an engine in accordance with a fourth exemplary embodiment of the invention.

### DETAILED DESCRIPTION WITH REFERENCE TO THE DRAWINGS

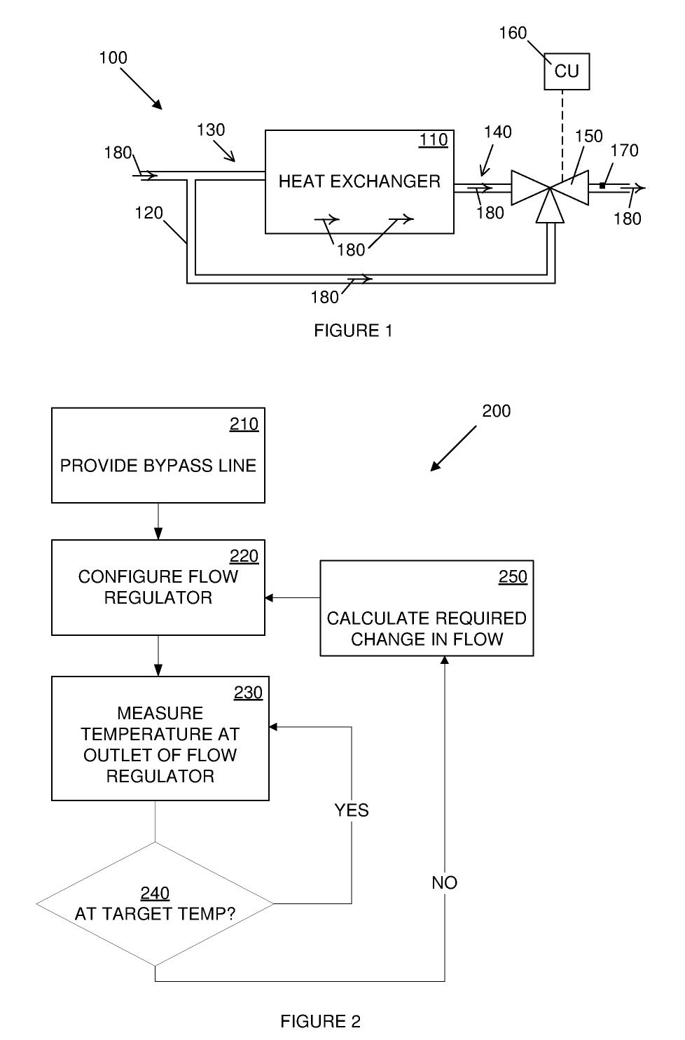

FIG. 1 shows a schematic illustration of an engine fluid temperature regulating system (100) in accordance with an exemplary embodiment of the invention. The system includes a heat exchanger (110), and a bypass line (120) connected in parallel with the heat exchanger (110). In the present embodiment, the heat exchanger is of a type that cools down a fluid flowing through it. The bypass line is connected at one end thereof to an inlet (130) of the heat exchanger (110), and at another end is connected to an outlet (140) of the heat exchanger (110) via a flow regulator, in the present embodiment a three-way controllable valve (150). A control unit (160) is in communication with the valve (150) and operable to control it in order to control a proportion of fluid flowing through the heat exchanger and the bypass line, respectively. The three-way valve (150) has two inlets, one connected to the outlet of the heat exchanger (110), and one connected to an outlet of the bypass line (120). The three-way valve (150) has one outlet, which is connected to an engine component where the fluid is required. A temperature sensor (170) is provided at the outlet of the valve. Flow directions (180) of fluid within the system (100) are indicated in FIG. 1.

A method of operation of the system (100) of FIG. 1 is illustrated in the flow diagram (200) shown in FIG. 2. The bypass line (120) is provided (210) and connected in the exemplary system as shown in FIG. 1. Initially, the flow regulator is configured (220) to allow a proportion of fluid in the system of FIG. 1 to travel through the heat exchanger (110), and a proportion of fluid to travel through the bypass line (120). In the present embodiment, at start-up of the system (100) the proportion is set to allow substantially the same volume of fluid to flow through the heat exchanger (110) and the bypass line (120), respectively.

The temperature sensor (170) is used to measure (230) the temperature at the outlet of the valve, after the fluid that traveled though the heat exchanger (110) and the fluid that traveled through the bypass line (120) have mixed. The temperature is compared (240) to a target temperature range stored in a memory element of the control unit (160). If the temperature is within a target temperature range, the proportion of flow through the heat exchanger (110) and the proportion of flow through the bypass line (120) may remain the same, without any adjustments to the valve (150) required. The temperature at the outlet of the valve will, however, be continually measured (230), possibly at predetermined intervals such as every five seconds, to determine when adjustments to the valve is required. When the measured temperature is outside an acceptable range, an adjustment to the proportion of fluid flowing through the heat exchanger and the bypass line will be required.

If the temperature is too low, it typically indicates that the heat exchanger is cooling the fluid too much. As a result, proportionally less fluid should flow through the heat exchanger to allow the mixed fluid at the exit of the valve to have a higher temperature. The control unit (160) calculates (250) a required change in the proportion of flow required to provide a higher temperature at the outlet of the valve (150), but which will fall within the acceptable range, and configures the valve (150) accordingly at step (220).

If the temperature is too high, it typically indicates that the heat exchanger is not cooling the fluid enough. As a result, proportionally more fluid should flow through the heat exchanger to allow the fluid to cool down to within a target temperature range. As before, the control unit (160) calculates a required change in the proportion of flow required to provide a lower temperature at the outlet of the valve (150) which falls within the acceptable range at step (250), and configures (220) the valve (150) accordingly.

It should be noted that the amount of adjustment in the proportion of flow will determine the rate of change in the temperature at the outlet of the valve. If the valve is adjusted from a substantially equal proportion of flow to a proportion such that substantially no fluid flows through the heat exchanger, the temperature may be expected to increase relatively quickly. If the valve is adjusted from a substantially equal proportion of flow to a proportion such that only a small proportion of fluid flows through the bypass line, the temperature may be expected to decrease relatively quickly.

It will be apparent to a person skilled in the art that continuous monitoring of the temperature at the outlet of the valve will allow the control unit to continuously adjust the proportion of fluid flow through the bypass line and heat exchanger to ensure an optimum temperature, or to at least strive to attain an optimum temperature. It is envisaged that the temperature will continuously vary during operation of the engine as a result of various circumstances, depending, amongst others, on the specific heat exchanger to which the system is applied.

It should be noted that a variety of temperature sensors and temperature sensing configurations may be employed to allow the control unit to adjust the valve as required. A temperature sensor may, for example, be provided at the inlet of the heat exchanger in combination with, or instead of, at the outlet of the valve as shown in FIG. 1. The control unit may be configured such that measurement of the inlet temperature may be used in determining when adjustments to the valve may be required. A difference between the two temperatures may be an indication of the efficiency of the heat exchanger, indicating the extent to which an adjustment in the proportion of fluid flow between the heat exchanger and bypass line will influence the two temperatures.

Furthermore, an ambient air temperature sensor may also be provided. The ambient air temperature may also be employed by the control unit in calculating the required adjustments to the valve—a relatively low ambient air temperature may cause the heat exchanger to cool fluid more than a moderate ambient air temperature. This may be used in calculating the adjustment required when configuring the valve. If, for example, more fluid needs to travel through the heat exchanger, a smaller proportion of fluid may need to be sent through the heat exchanger when the ambient air temperature is relatively low than when the ambient air temperature is moderate, as the heat exchanger will cool the fluid more at the lower ambient air temperature.

It is envisaged that the memory element of the control unit may store all of the necessary temperature values for the possible locations at which temperature sensors can be placed so that it may respond to measured temperatures accordingly. Alternatively, algorithms may be stored on the memory element which can take into account variables such as temperatures which may be observed by the system.

It will be apparent to a person skilled in the art that the valve may allow all fluid to flow through the heat exchanger, or all fluid to flow through the bypass line. Should, for example, all fluid already be flowing through the bypass line, and the control unit calculate that the temperature of the fluid is still too low, the control unit will not be able to make any further suitable adjustment to the flow regulator to compensate for the low temperature. The control unit may accordingly include an alarm to warn an operator of the vehicle of this fact enabling the operator to take alternative remedial action as required. Similarly, when the temperature is too high and all fluid is already flowing through the heat exchanger, the operator may be informed of this fact. This may serve as an additional warning above standard temperature warning alarms provided with most engines.

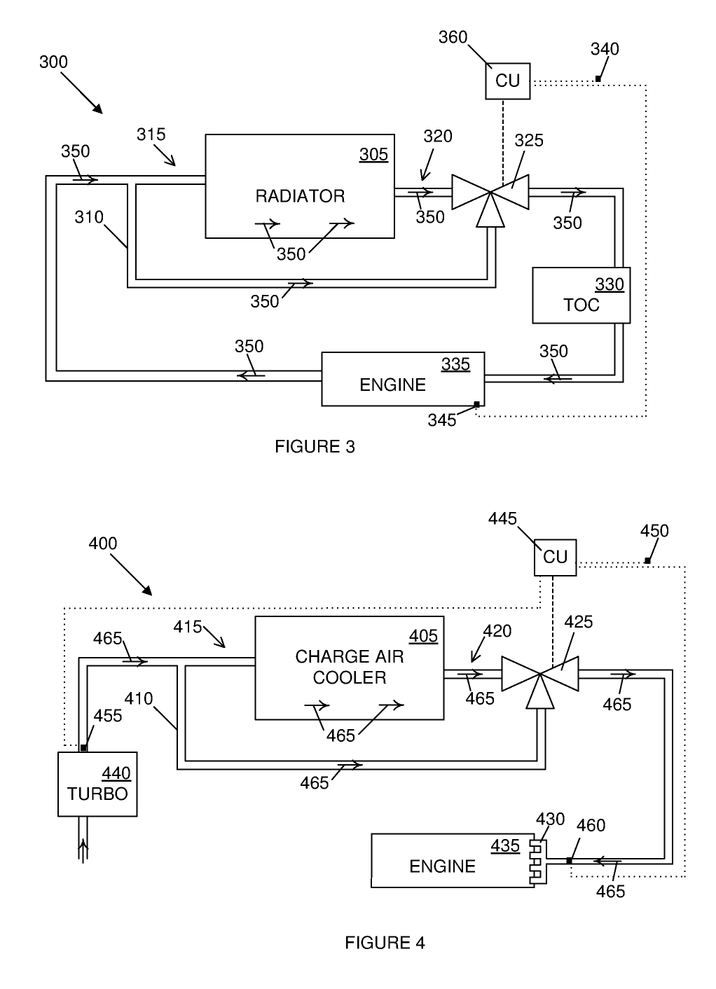

FIG. 3 shows a schematic illustration of an engine fluid temperature regulating system (300) in accordance with a second exemplary embodiment of the invention. In this embodiment, the heat exchanger is a radiator (305). A bypass line (310) is connected in parallel with the radiator (305), and is connected directly to an inlet (315) of the radiator, and at an outlet (320) of the radiator via a three-way valve (325). A first inlet of the three-way valve (325) is connected to the outlet (320) of the radiator (305), and a second inlet of the three-way valve (325) is connected to the outlet of the bypass line (310). An outlet of the three-way valve (325) is connected to an inlet of a transmission oil cooler (330), and an outlet of the transmission oil cooler (330) is connected to a coolant inlet of an engine (335). The engine includes a radiator valve which automatically opens to allow coolant to flow through the system and cool the engine when the engine is at a too high temperature, and to close when the engine is at a too low temperature. A coolant outlet of the engine (335) is connected to the inlet (315) of the radiator (305), where the inlet of the bypass line (310) is also connected. The system shown in FIG. 3 can be considered a closed system, as the same coolant travels through the system.

A control unit (360) is in communication with the valve (325) and operable to control the valve so as to control a proportion of fluid flowing through the radiator (305) and the bypass line (310), respectively. An ambient air temperature sensor (340) and an engine temperature sensor (345) are provided, both also in communication with the control unit (360).

When the radiator valve is open, coolant flows within the system in the flow directions (350) as indicated. The coolant absorbs heat from the engine (335), and exits the engine at a coolant outlet. From there, it flows to the respective inlets of the radiator (305) and the bypass line (310). Heat of coolant flowing through the radiator (305) is dispersed to the ambient air, until the coolant exits the radiator (305) at an outlet thereof and towards an inlet of the three-way valve (325). Coolant flowing through the bypass line combines with coolant flowing through the radiator at the three-way valve (325). From there, the coolant flows to an inlet of the transmission oil cooler (330), where the coolant absorbs some heat of the transmission oil. After exiting the transmission oil cooler (330) at an outlet thereof, coolant flows towards a coolant inlet of the engine (335), where it again absorbs heat of the engine (335) and repeats the same cycle set out above.

The system (300) aims to keep the temperature of the engine high enough to ensure that the radiator valve remains open during operation of the engine under extreme cold weather conditions, but still low enough to ensure safe engine operation. This may serve to limit thermal cycles experienced by the radiator, preventing possible damage or cracking as explained previously. In extreme cold weather conditions, the control unit (360) will configure the valve (325) such that the coolant is not cooled to such an extent that the engine temperature is reduced enough to close the radiator valve. Measurement of engine temperature via the engine temperature sensor (345) may assist the control unit (360) in suitably adjusting the valve (325). By allowing a proportion of coolant to flow through the bypass line, instead of through the radiator, the resultant mix exiting the outlet of the valve may be of a sufficient temperature that the engine remains above a minimum temperature at which the radiator valve remains open. However, the control unit will be configured to still prevent excessively high engine temperatures.

In the present embodiment, the ambient air temperature measured by the ambient air temperature sensor (340) is used to calculate the extent to which the valve should be configured if the engine temperature falls outside of an acceptable range. Furthermore, the ambient air temperature is used to calculate the initial configuration of the valve at start-up. If the ambient air temperature is moderate, the valve may be closed initially to allow all coolant to travel through the radiator. If the ambient air temperature is relatively low, the valve may be opened initially so as to immediately allow some coolant to pass through the bypass valve upon initial coolant flow. The valve may then be at a suitable configuration when the radiator valve in the engine is initially opened, and coolant begins to flow through the system (300).

It should be noted that the exact configuration shown in this embodiment may differ depending on the exact cooling system employed. For example, a transmission oil cooler need not form part of the system, as a cooling system may be provided where a transmission oil cooler is not connected in line with a radiator and engine.

FIG. 4 shows a schematic illustration of an engine fluid temperature regulating system (400) in accordance with a third exemplary embodiment of the invention. In the present embodiment, the heat exchanger is a charge air cooler (405). A bypass line (410) is connected in parallel with the charge air cooler (405), and is connected directly to an inlet side (415) of the charge air cooler, and to an outlet side (420) of the charge air cooler via a three-way valve (425). A first inlet of the three-way valve (425) is connected to the outlet (420) of the charge air cooler (405), and a second inlet of the three-way valve (425) is connected to the outlet of the bypass line (410). An outlet of the three-way valve (425) is connected to an intake manifold (430) of an engine (435). An exhaust of the engine is not shown. The system (400) further includes a turbo (440) which has an air inlet allowing ambient air to enter the turbo, and an outlet connected to the inlet of the charge air cooler (405) and to the bypass line (410).

A control unit (445) is in communication with the valve (425) and is operable to control the valve in order to control a proportion of air flowing through the charge air cooler (405) and the bypass line (410), respectively. An ambient air temperature sensor (450), a turbo outlet air temperature sensor (455), and a system air temperature sensor (460) are provided, all in communication with the control unit (445). The system air temperature sensor is located before the intake manifold (430).

Air is required for operation of the engine (435). Ambient air enters the system via the air intake of the turbo (440). Operation of the turbo (440) heats the air from its initial ambient temperature. After exiting the turbo at its outlet, air enters the charge air cooler via its inlet (415), and/or the bypass line (410). Air flowing through the charge air cooler is cooled, its heat being dispersed back to the ambient air. An outlet of the charge air cooler (405) is connected to a first inlet of a three-way valve (425), and an outlet of the bypass line (410) is connected to a second inlet of the three-way valve (425). Air from the charge air cooler and the bypass line combines and mixes at the valve, and travels through the outlet of the valve towards the intake manifold (430) of the engine (435). Air is used for combustion in the engine, and released as part of exhaust gasses exiting the engine. Flow directions (465) of the air within the system (400) are shown in FIG. 4. The system of FIG. 4 may be considered an open system, as ambient air continuously enters the system and leaves the system as part of exhaust gasses.

In extreme cold weather conditions, the system (400) aims to keep the temperature of the air at the intake manifold (430) high enough such that frost is prevented from forming in the manifold, but still low enough such that the engine runs efficiently. By allowing a proportion of air to flow through the bypass line, instead of through the charge air cooler, the resultant mix exiting the outlet of the valve may be of a sufficient temperature that the air is above a minimum temperature at which frost may tend to form. However, the control unit will be configured to still prevent excessive air temperature.

It is envisaged that a memory element of the charge air cooler will include data relating to a target system air temperature, measured at the system air temperature sensor (460) at the intake manifold (430), which will ensure substantially optimal engine operation, without the risk of frost forming in the intake manifold. The valve will then be configured by the control unit so that the target system air temperature be reached.

The ambient air temperature is used to calculate the initial configuration of the valve at start-up. If the ambient air temperature is moderate, the valve may be closed to allow all air to flow through the charge air cooler. If the ambient air temperature is relatively low, the valve may be opened so as to immediately allow some air to pass through the bypass line. Additionally, temperature measured at the turbo outlet air temperature sensor (455) may be employed by the control unit to estimate when a changed configuration of the valve will be required. The valve may then be configured pre-emptively to avoid changes only in response to an undesirable measured temperature at the system air temperature sensor (460) at the intake manifold. The ambient air temperature may also be used to pre-emptively adjust the valve in response to an expected rise in system air temperature.

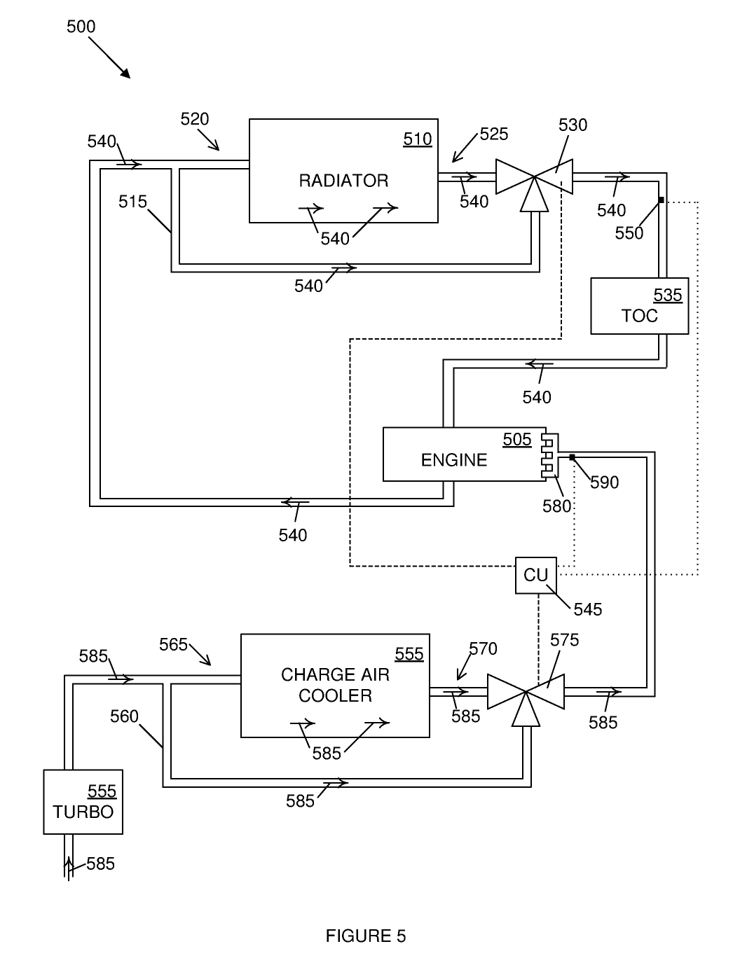

FIG. 5 shows a schematic of a system (500) substantially combining the exemplary systems of FIG. 3 and FIG. 4 into a system for a single engine (505).

A first part of the system (500) is similar to the system of FIG. 3 and includes a radiator (510) with a bypass line (515) connected in parallel thereto. An inlet of the bypass line is connected directly to an inlet (520) of the radiator (510). An outlet of the bypass line is connected to an outlet (525) of the radiator via a first three-way valve (530). The outlet of the radiator is connected to a first inlet of the first three-way valve, and the outlet of the bypass line is connected to a second inlet of the three-way valve. An outlet of the valve (530) is connected to an inlet of a transmission oil cooler (535), and an outlet of the transmission oil cooler is connected to a coolant inlet of the engine (505). A coolant outlet of the engine is connected to the inlet of the radiator (510) and bypass line (515).

Coolant flows within the first part of the system as described with reference to FIG. 3. Flow directions (540) of coolant are indicated in FIG. 5. In the present embodiment, a temperature sensor is provided after the outlet of the three-way valve (530), and before the transmission oil cooler (535). A control unit (545) is provided and configured to adjust the first three-way valve as required and similar to that described with reference to FIG. 3. It should be noted that in the present embodiment, a temperature sensor is not provided at the engine, but rather between the three-way valve and the transmission oil cooler. The control unit will be configured to determine the required configuration of the three-way valve based solely on the temperature reading of a first temperature sensor (550) shown in FIG. 5. As the transmission oil cooler will only increase the temperature of the coolant, there need not be a concern that the engine will cool down to a temperature too low if the temperature measured at the first temperature sensor (550) is sufficient. A target temperature at which the control unit aims to keep the coolant will be set and stored in a memory element of the control unit. Such a target temperature may be determined by experimentation or trials. The target air temperature will be such that the radiator valve of the engine remains open, so that coolant may continue to flow within the first part of the system.

A second part of the system (500) is similar to the system of FIG. 4 and includes a charge air cooler (555) with a bypass line (560) connected in parallel thereto. An inlet of the bypass line is connected directly to an inlet (565) of the charge air cooler (555). An outlet of the bypass line is connected to an outlet (570) of the charge air cooler (555) via a second three-way valve (575). The outlet (570) of the charge air cooler (555) is connected to a first inlet of the second valve (575), and the outlet of the bypass line (560) is connected to a second inlet of the second valve (575). An outlet of the second valve (575) is connected to an intake manifold (580) of the engine (505).

Air flows within the second part of the system substantially as described with reference to FIG. 4. Flow directions (585) of air in the second part of the system are indicated in FIG. 5.

In the present embodiment, a second temperature sensor (590) is provided at the intake manifold (580) of the engine. The control unit (540) is also configured to adjust the second three-way valve as required and similar to that described with reference to FIG. 4. A target temperature at which the control unit aims to keep air entering the intake manifold will be set and stored in the memory element of the control unit. Such a target temperature may also be determined by experimentation or trials. The target air temperature will be such that substantially optimal engine operation is allowed, without the risk of frost forming in the intake manifold.

It should be noted that the above described systems were merely described with reference to simplified schematics of the system. A person skilled in the art will immediately note that the layouts of the system components are not as they will appear in an actual vehicle, but were merely illustrated to allow for simplified reference purposes.

The systems described above provide numerous advantages over current systems and methods employed to address the same issues. The system may remain on a vehicle when the vehicle is operating at moderate temperatures, preventing overheating. Limited or no maintenance is required in order to set-up the system. The system is installed on the vehicle once, and need not be removed or re-installed when not required. The system will automatically close the bypass lines when the engine is operated in moderate or normal conditions, without operator intervention required. Only standard maintenance requirements, in line with that of a normal vehicle, are expected. No additional operator training, or at the most limited training, may be required. Furthermore, problems experienced by covers accidentally left on heat exchangers are removed, as well as possible heat strain experienced by a charge air cooler covered by a cover. Additionally, air flow is not restricted, as may be the case when a radiator is covered.

The present invention provides a system which may be fitted to a vehicle engine, which provides automatic adjustment in order to ensure temperatures associated with heat exchangers and their associated fluids, are at target temperatures. The system provides a flexible solution, as different extents of intervention in the normal operation of the system components may be achieved by the bypass line, and the proportional adjustability of fluid flow through it and the heat exchangers. This may allow for changes in weather conditions, operating conditions, or the like, which require different extents of intervention to ensure optimal operation of system components, which has not previously been possible. The present invention may enable a substantially steady state temperature during cold weather as far as possible between an engine and the relevant cooling equipment by using heat generated by engine or vehicle components, in combination with ambient air.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

In particular, any position may be chosen for temperature sensors which provide the control unit with suitable temperature measurements. Additionally, a large amount of such sensors may be provided. It is envisaged that the control unit may use any number of such temperature measurements as input values in order to calculate a required configuration of the relevant control valve to ensure optimal operation of the system. Furthermore, experimentation or tests may show how the system will typically react for a temperature measurement taken at any location within the system, which may allow measurements to be taken wherever suitable.

Although only a controllable three-way valve was used in the description above, any suitable controllable valve may be used. More than one valve may be employed in the system, as long as the valve, or combination of valves, may be configured to provide the desired proportional flow of fluid within the system. A three-way valve similar to those used in the embodiments described above may also be located before a heat exchanger, with an inlet of the heat exchanger receiving a fluid, and with a first outlet of the valve connected to an inlet of the heat exchanger, and a second outlet of the valve connected to the bypass line. Valves located before the heat exchanger will allow similar control of the system as described above. Furthermore, the valves may be controllable in any suitable way, including electrically or pneumatically.

The systems described above may be provided as an after-market add-on system, and may be retro-fitted to existing vehicles. Alternatively, the system may be incorporated at a time of manufacture of a vehicle, and may be provided as an addition to newly built vehicles. Furthermore, the control unit may be incorporated into an on-board vehicle interface module.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. An engine fluid temperature regulating system for an engine, the system including a bypass line configured to be connected in parallel with a heat exchanger between an inlet and an outlet thereof, and a flow regulator configurable to regulate a proportion of fluid flowing through the bypass line and heat exchanger, respectively, between the inlet and the outlet.

2. The system as claimed in claim 1 including a temperature sensor at the inlet and/or the outlet of the heat exchanger, and wherein the flow regulator is configured to adjust the proportion of fluid flowing through the heat exchanger and the bypass line, respectively, between the inlet and the outlet so that fluid enters the heat exchanger and bypass line at a target entry temperature, or so that fluid exiting the heat exchanger and the bypass line is at a target exit temperature when mixed together.

3. The system as claimed in claim 2 which includes a control unit configured to automatically adjust the flow regulator to obtain the target entry or exit temperature.

4. The system as claimed in claim 3 which includes an ambient air temperature sensor for measuring the ambient air temperature, and wherein the control unit is configured to take into account the ambient air temperature in adjusting the flow regulator.

5. The system as claimed in claim 1 wherein the flow regulator is a three-way controllable valve.

6. The system as claimed in claim 1 wherein the heat exchanger is a radiator or a charge air cooler.

7. A method for regulating engine fluid temperature for an engine including the steps of:
connecting a bypass line in parallel with a heat exchanger between an inlet and an outlet thereof; and
regulating, with a flow regulator, a proportion of fluid flowing through the heat exchanger and the bypass line, respective, between the inlet and the outlet.

8. The method as claimed in claim 7 which includes the step of measuring a temperature at the inlet and/or the outlet of the heat exchanger, and wherein the step of regulating a proportion of fluid flowing through the heat exchanger and the bypass line includes regulating the flow such that fluid enters the heat exchanger and bypass line at a target entry temperature, or so that fluid exiting the heat exchanger and the bypass line is at a target exit temperature when mixed together.

9. The method as claimed in claim 8 wherein a control unit is operable to automatically adjust the flow regulator to regulate fluid flow to obtain the target entry or exit temperature.

10. The method as claimed in claim 9 including the step of measuring an ambient air temperature, and wherein the step of regulating a proportion of fluid flowing through heat exchanger and the bypass line, respectively, includes taking into account the measured ambient air temperature.

11. An engine fluid temperature regulating system for an engine, the system including:
a first bypass line configured to be connected in parallel with a radiator of an engine between an inlet and an outlet thereof;
a first flow regulator configurable to regulate a proportion of coolant flowing through the radiator and the first bypass line, respectively, between the inlet and the outlet;
a second bypass line configured to be connected in parallel with a charge air cooler of an engine between an inlet and an outlet thereof; and
a second flow regulator configurable to regulate a proportion of air flowing the charge air cooler and the second bypass line, respectively, between the inlet and outlet thereof.

12. The system as claimed in claim 11, including a first temperature sensor at the inlet and/or the outlet of the radiator, wherein the first flow regulator is configured to regulate a proportion of coolant flowing through the radiator and the first bypass line so that coolant enters the radiator and first bypass line at a first target entry temperature, or so that coolant exiting the radiator and the first bypass line is at a first target exit temperature when mixed together, and including a second temperature sensor at the inlet and/or the outlet of the charge air cooler, wherein the second flow regulator is configured to regulate a proportion of air flowing through the charge air cooler and the bypass line, respectively, so that air enters the charge air cooler and second bypass line at a second target entry temperature, or so that air exiting the charge air cooler and the second bypass line is at a second target exit temperature when mixed together.

13. The system as claimed in claim 12 including a control unit configured to automatically adjust the first and the second flow regulators to obtain the first and/or second target entry or exit temperatures.

14. The system as claimed in claim 13 including an ambient air temperature sensor, and wherein the control unit is configured to take into account the ambient air temperature in adjusting the first and second flow regulators.
